(19) United States
(12) Patent Application Publication
(10) Pub. No.: US 2022/0275613 A1
(43) Pub. Date: Sep. 1, 2022

(54) IMPROVEMENTS TO A DRAIN ROD SYSTEM

(71) Applicant: Power Box AG, Zug (CH)

(72) Inventor: Daniel Pikarski, Somerset (GB)

(73) Assignee: Power Box AG, Zug (CH)

(21) Appl. No.: 17/634,578

(22) PCT Filed: Aug. 12, 2020
(86) PCT No.: PCT/EP2020/072667

§ 371 Date: Feb. 11, 2022

(30) Foreign Application Priority Data
Aug. 15, 2019 (GB) 1911732.4

(51) Int. Cl. E03C 1/302; B08B 9/043; F16B 7/04

(52) U.S. Cl. CPC E03C 1/302; B08B 9/0436; F16B 7/042; B08B 2209/04; E03F 9/005

(57) ABSTRACT

The invention relates to a drain rod system which is formed of a plurality of elongate members which can be selectively engaged end to end to be in an in-use position and disengaged to be in a storage position. The engagement is achieved by the provision of first and second engagement means at respective ends of at least some of the said elongate members and the first engagement means of a first elongate member and a second engagement means of a second elongate member can be moved linearly with respect to each other when engaging and disengaging with any relative rotational movement substantially prevented.

The present invention relates to an improved drain rod system and means for allowing the same to be moved between in-use and storage positions.

Drain rod systems are well-known and typically comprise a series of elongate members, which can be joined together end-to-end and, at one end of the system, there is provided a cleaning head which allows the cleaning operation to be performed along the drain or other passage along which the system is pushed or pulled. A required number of members can be joined together end-to-end to form the system to the required length so as to allow the cleaning head to be moved along the drain or passage to perform the cleaning operation for a required length. The drain rods can have a degree of flexibility to allow deviations in the drain or passage to be taken into account but, typically, the drain rod system, when formed, is relatively straight and elongate.

Due to the length of the system which can be required for the same to be usable when the members are located end-to-end, there is a need to be able to disengage the same so as to allow the rods to be placed side by side and stored. Thus, there is a need to be able to provide location means at the said ends of the respective rods so as to allow the same to be moved between engaged and disengaged and thereby allow the rods to be moved between in-use and storage positions relatively quickly whilst, at the same time, ensuring that the engagement between the ends of the rods is sufficiently secure so as to prevent the same from being disengaged when in-use. If disengagement did occur between respective elongate members when the same are positioned within the drain or passage, then this would provide a further obstacle in a potentially already blocked drain and it can be very difficult to retrieve the detached members of the system from the drain itself.

Typically, the drain rod systems which are known, have threaded attachment means in the form of a male threaded member at an end of one of the rods and a female threaded portion at the end of another of the rods and when the male and female threaded portions are brought together and the rods are respectively rotated, so threaded engagement between the members can be achieved in a secure and robust manner. However, when one considers the conditions in which the rods can be used there is a tendency for the ingress of dirt and debris to potentially damage the threads on the thread portions and/or make it difficult for the threads to be engaged and disengaged, which can be frustrating for the user.

The aim of the present invention is therefore to provide a drain rod system which allows for the engagement of elongate members together in an end-to-end relationship to form the drain rod system to the required length and to allow the engagement to be achieved in a manner which is secure and also resistant to problems caused by dirt and/or debris.

In a first aspect of the invention, there is provided a drain rod system including at least first and second elongate members, said system moveable between an in-use position in which said elongate members are joined together end-to-end, and a storage condition in which the elongate members are disengaged, said elongate members provided, at the respective ends which are to be joined together in the in-use position, with first engagement means and second engagement means and wherein the said first engagement means includes a female portion and said second engagement means includes a male portion for engagement in the said female portion and, during engagement and when engaged, the respective configuration of the male and female portions substantially prevents relative rotation of the elongate members.

In one embodiment, the said biased portion is retained in a retracted position as the male and female portions of the location means are engaged and once the male and female portions are substantially located in an engaged position, the biased portion is freed to move to an engaging position with a recess or aperture located in the other of the elongate members.

In one embodiment, to disengage the said elongate members, a force is applied to retract the biased portion to move the same out of location with the said recess or aperture and thereby allow linear movement between said male portion of the said second engagement means and female portion of the first engagement means so as to remove the male and female portions from engagement.

In one embodiment, the first engagement means and the second engagement means are formed in respective collars which are attached to respective shafts which are tow be joined together.

In one embodiment, the relative rotation of the elongate members is prevented when the same are engaged, by one or more corners or flat edges provided on the male and female portions which are provided in a matching configuration.

Typically, the arrangement of the male and female portion configurations, allow the elongate members to be linearly moved towards each other to be engaged and, as they do so, for the biased means to be released to move into a position to be released and engaged with the aperture or recess.

Thus, in accordance with the invention, no rotational movement is permitted or required in order to allow the engagement of the said elongate members.

In one embodiment, there are provided a plurality of said elongate members and each of the elongate members is provided with a first engagement means or a second engagement means at at least one end thereof. Typically the majority of the elongate members in the system will have a second engagement means with a male portion at one end and a first engagement means with a female portion at the opposing end of the said elongate member.

In one embodiment, at least one of the elongate members has, at one end, a cleaning means which forms the leading end of the system as it is inserted along the drain or passageway.

In one embodiment, the said cleaning means is selectively attached to the end of the said elongate member using the same form of location means as is used to allow the selective engagement of the elongate members to each other and thereby allows the selective fitting of a particular cleaning means to a leading end of the system.

In an alternative embodiment, the cleaning means provided at the leading end of the elongate member, is permanently fixed therewith.

In one embodiment the movement of the retaining portion to the engaged position is automatic when in line with the recess or aperture.

Specific embodiments of the invention are now described with reference to the accompanying drawings wherein:

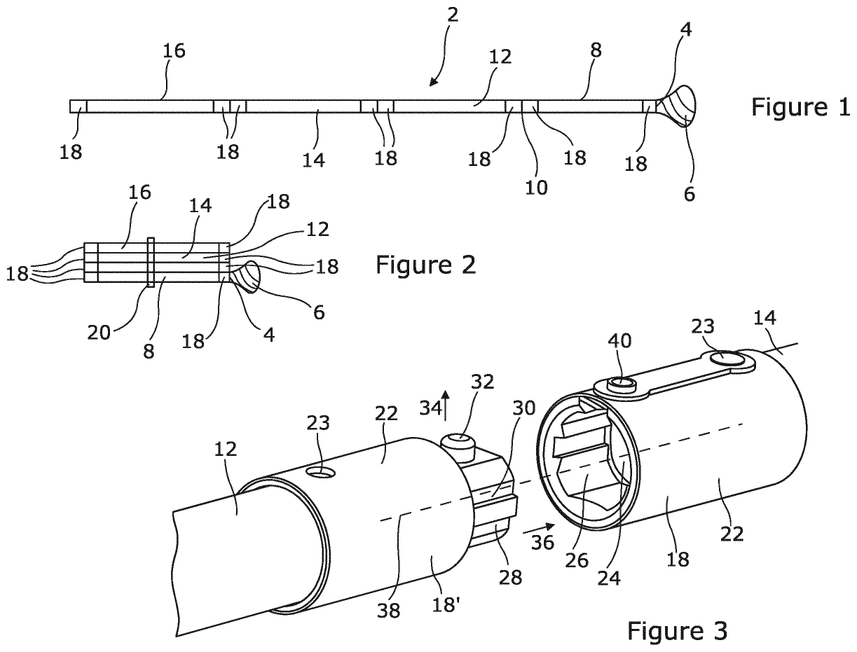

FIG. 1 illustrates a drain rod system in accordance with one embodiment of the invention in an in-use condition;

FIG. 2 illustrates the system in FIG. 1 with the drain rod system in a storage condition;

FIG. 3 illustrates a first configuration of location means in accordance with the invention; and

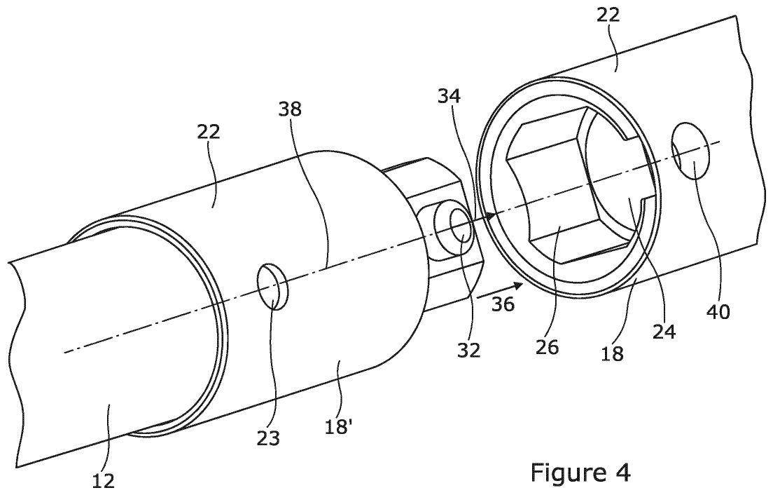

FIG. 4 illustrates a second embodiment of location means in accordance with the invention.

Referring firstly to FIG. 1, there is illustrated a drain rod system 2 in accordance with one embodiment of the invention in an in-use condition and it is shown that the drain rods system includes a leading end 4, at which there is located a cleaning means 6 which can be designed and sized for the particular drain cleaning job for which the same is to be used. The cleaning means is connected at the leading end 4 to a first elongate member 8 which, in turn, is joined at the opposing end 10 to a further elongate member 12 and, in turn, further elongate members 14, 16. It should be appreciated that the required number of elongate members can be joined end-to-end so as to form the drain rod system to the required length so as to be able to locate the cleaning means at the required location along the drain which is to be cleaned.

Because of the proposed length of the drain rod system, it is not possible to easily store the same and, as a result, at least some of the elongate members are provided with respective first engagement means 18 at an end thereof and second engagement means at opposing ends thereof so as to allow the same to be disengaged when not in-use and moved to a storage condition as shown in FIG. 2 in which typically the elongate members are placed side by side and may be tied or otherwise located together 20 for storage.

In order to be able to move the drain rod system between the said storage and an in-use conditions, it is necessary for the first engagement means 18 provided between the elongate members to be secure, when engaged and furthermore, to be relatively easily moveable between engaged and disengaged conditions.

Referring now to FIG. 3, there is illustrated a first embodiment of the first engagement means 18 in accordance with the invention and which are connected to an end of the respective elongate members 12, 14 via collars 22 and rivets 23 or other connection means. The first engagement means 18 is provided with a female portion 24 which has an inner wall configuration 26 formed of a series of straight edges which are angularly offset. Second engagement means 18′ fitted to the end of the elongate member 12 which is to be joined to the elongate member 14 includes a male engagement portion 28 which is provided with an external face 30 which is formed so as to substantially match the configuration of the internal face 26 of the female portion 24. Also provided, is a biased engagement portion 32 which is biased by a spring (not shown) which is located within the male portion 28 and is biased in the direction indicated by arrow 34.

Thus to achieve engagement of the elongate members relative movement, such as movement of the male portion 28 as indicated by arrow 36 into the female portion brings the internal face 26 of the first engagement means and external face 30 of the second engagement means into mutual location so as to allow the engagement of the male 28 and female 24 portions in the required configuration and prevents rotation of the elongate members about axis 38.

In one embodiment, the external face 30 of the male portion and the internal face 26 of the female portion are formed so that insertion of the male and female portions together, is only possible in one orientation. This therefore ensures that the biased portion 32 is presented into the female portion in the required location so that when it reaches the aperture 40, the biasing means causes the portion 32 to move upwardly and into the aperture to thereby engage in the same and the biasing means ensures that this engagement is continued during use of the joined drain rods. Thus, the shaping of the external face of the male portion and the internal face of the female portion, prevents relative rotation of the elongate members and the engagement of the biased portion in the aperture prevents relative linear movement of the elongate members along the axis 38 and thereby ensures the engagement of the elongate members 12 and 14 and other elongate members is achieved securely, robustly and quickly.

FIG. 4 illustrates an alternative embodiment of the first engagement means and the second engagement means in which the same reference numerals are used for the same features and it will be appreciated that in this case, the configuration and shape of the internal face of the female location means and the male location means are different to that shown in FIG. 3 but still achieve the same result in preventing relative rotational movement between the elongate members and relative linear movement between the elongate members so as to maintain the members in the engaged position when the engagement means are connected.

In both embodiments, in order to release the engagement means, the biased portion 32 is pressed inwardly towards the axis 38 and the biased portion is then released from the aperture 40 and the elongate members can then be slid apart to disengage the male and female portions 28, 24 and hence the elongate members and allow them to be stored side by side.

1. A drain rod system including at least first and second elongate members, said system moveable between an in-use position in which said elongate members are joined together end-to-end, and a storage condition in which the elongate members are disengaged, said elongate members provided, at the respective ends which are to be joined together in the in-use position, with first engagement means and second engagement means and wherein the said first engagement means includes a female portion and said second engagement means includes a male portion for engagement in the said female portion and, during engagement and when engaged, the respective configuration of the male and female portions substantially prevents relative rotation of the elongate members.

2. A drain rod system according to claim 1 wherein at least one of said engagement means further includes a biased portion which is biased to move into an engaging position with the other of said engagement means when the said male and female portions are engaged.

3. A drain rod system according to claim 2 wherein the said biased portion is retained in a retracted position as the male and female portions of the location means are moved into engagement and, once the male and female portions are mutually located, the biased portion is able to move to an engaging position with a recess or aperture located in the other of the elongate members.

4. A drain rod system according to claim 3 wherein to disengage the said elongate members, a force is applied to move the biased portion out of location with the said recess or aperture and thereby allow linear movement between the said male and female portions so as to remove the male and female portions from engagement.

5. A drain rod system according to claim 1 wherein the first engagement means and the second engagement means are formed as part of a respective collar which is attached to an end of the elongate member.

6. A drain rod system according to claim 1 wherein the relative rotation of the elongate members is prevented when the same are engaged by one or more corners or flat faces provided on the male and female portions which are provided in a matching configuration.

7. A drain rod system according to claim 1 wherein the configurations of the male and female portions allow the elongate members to be linearly moved towards each other to be engaged and, as they do so, for the biased means to be linearly moved to a position to be engaged with the aperture or recess.

8. A drain rod system according to claim 1 wherein there is provided a plurality of said elongate members and each of the elongate members is provided with a first engagement means and a second engagement means on at least one end thereof.

9. A drain rod system according to claim 8 wherein the majority of the elongate members have a first engagement means at a first end and a second engagement means at a second, opposing end.

10. A drain rod system according to claim 1 wherein at least one of the elongate members has, at one end, a cleaning means which forms the leading end of the system as it is inserted along the drain or passageway to clean the same.

11. A drain rod system according to claim 10 wherein the said cleaning means are selectively attached to the end of the said elongate member using the same form of first and second engagement means.

12. A drain rod system according to claim 3 wherein the movement of the retaining portion to the engaged position is automatic when in line with the recess or aperture.

13. A drain rod system according to claim 2 wherein the first engagement means and the second engagement means are formed as part of a respective collar which is attached to an end of the elongate member.

14. A drain rod system according to claim 3 wherein the first engagement means and the second engagement means are formed as part of a respective collar which is attached to an end of the elongate member.

15. A drain rod system according to claim 4 wherein the first engagement means and the second engagement means are formed as part of a respective collar which is attached to an end of the elongate member.

16. A drain rod system according to claim 1 wherein there is provided a plurality of said elongate members and each of the elongate members is provided with a first engagement means on at least one end thereof.
